(19) United States
(12) Patent Application Publication
(10) Pub. No.: US 2008/0135814 A1
(43) Pub. Date: Jun. 12, 2008

(54) COMPOSITION FOR MANUFACTURING SEPARATOR FOR PEMFC AND SEPARATOR FOR PEMFC MANUFACTURED OUT OF THE SAME

(76) Inventor: Jhong-Ho Lee, Gyeonggi-do (KR)

Correspondence Address: JONES DAY, 222 EAST 41ST ST, NEW YORK, NY, 10017, US

(21) Appl. No.: 11/946,478

(22) Filed: Nov. 28, 2007

(30) Foreign Application Priority Data
Nov. 29, 2006 (KR) 10-2006-119260

(51) Int. Cl. H01B 1/14

(52) U.S. Cl. 252/508; 252/509

(57) ABSTRACT

The present invention relates to a composition for manufacturing a separator for PEMFC (Proton Exchange Membrane Fuel Cell) and a separator for PEMFC manufactured out of the same. The composition provided by the present invention includes 70 to 80 parts by weight of graphite powder; 3 to 10 parts by weight of carbon fiber; 1 to 5 parts by weight of metal oxide selected from the group consisting of magnesium oxide, aluminum oxide, calcium oxide and their mixtures; and 10 to 30 parts by weight of thermosetting resin selected from the group consisting of vinyl ester resin, phenol resin, epoxy resin and their mixtures. The separator for PEMFC manufactured out of the composition of the present invention has excellent electrical conductivity, mechanical strength and impermeability to hydrogen or oxygen gas, thereby considerably improving the performance of a fuel cell.

### BACKGROUND OF THE INVENTION

1. Field of the Invention

The present invention relates to a composition for manufacturing a separator for PEMFC (Proton Exchange Membrane Fuel Cell) and a separator for PEMFC manufactured out of the same, and in particular, to a composition for manufacturing a separator for PEMFC which has excellent electrical conductivity and mechanical strength and low gas permeation, and a separator for PEMFC manufactured out of the same.

2. Description of the Related Art

Generally, a fuel cell is a kind of electricity producing system for converting chemical energy of fuel to direct electrical energy, and has advantages of reduced environmental pollution materials and high thermal efficiency as electrical energy is directly generated without a combustion process. According to electrolytes used, such a fuel cell is classified into a proton exchange membrane fuel cell, a phosphoric acid fuel cell, a molten carbonate fuel cell, and a solid oxide fuel cell. Among them, the proton exchange membrane fuel cell has lower operating temperature, and consequently shorter start-up time and higher power density, as compared with the other fuel cells, and therefore, there have been a number of studies on the proton exchange membrane fuel cell.

The proton exchange membrane fuel cell includes a solid electrolyte membrane containing a sulfonic acid group, the solid electrolyte membrane should be maintained between 70% and 90% humidity so that hydrogen ions properly pass through the solid electrolyte membrane, and such a movement of the ions occurs with movement of electrons to produce electricity. In this way, the proton exchange membrane fuel cell is always at a strong acidic atmosphere (pH 2 to 3), and thus components should be resistant to corrosion.

The fuel cell includes a stack of a plurality of unit cells, each unit cell being assembled with a separator having a hydrogen gas providing and discharging groove formed at one side and an oxygen gas (in air) providing and discharging groove formed at the other side with regard to a membrane-electrode assembly (MEA) that consists of a solid electrolyte membrane, a catalyst and a gas diffusion layer. A voltage occurring from a unit cell is generally 0.6 volt to 0.8 volt, and thus, it is necessary to stack a plurality of unit cells so as to obtain a utility voltage (about 100 volt or more). Stacking of a plurality of unit cells allows a separator to use one side as a hydrogen providing side and the other side as an air providing side, and in the result, a separator may have the cathode side and the anode side (referred to as “a bipolar plate”), or unit cells may be separated from each other with regard to a separator (referred to as “a separator”).

Therefore, to manufacture a stack of good performance, stacking of unit cells requires a separator as a connection portion, having 1) good electrical conductivity for minimum voltage loss, 2) good mechanical strength sufficient for enduring pressure applied for connection when stacking, and 3) low gas permeation to prevent hydrogen or oxygen gas from passing through the separator itself, not an electrolyte membrane.

To meet these characteristics, a material used for the separator may include a metal material, a graphite material or a high molecular composite material. The metal material has good electrical conductivity but high corrosion risk, which causes trouble to durability, and the graphite material has poor mechanical property such as fragility and low economic efficiency caused by high cost, whereas the high molecular composite material has few corrosion risk, low cost and good electrical conductivity, which is known to be suitable for a separator material.

So far, a material technology for a separator using a high molecular composite material has been studied, starting from a technique (JP Laid-open Patent Publication No. 1981-138876) using graphite and phenol resin. As it could be expected from a well known fact, a sufficient amount of conductive material meets the requirement of low electrical conductivity. However, this reduces the content of resin, and consequently reduces a function as a binder, thereby resulting in low mechanical strength. Thus, JP Laid-open Patent Publication No. 2001-189160 and KR Laid-open Patent Publication No. 10-2005-0004204 suggested a composite including graphite, a thermosetting resin and a fabric base material as main components to reinforce a mechanical property, wherein in particular, the mechanical property is improved according to arrangement of the fabric base material. However, the prior arts did not teach any improvement for suppressing gas permeation. U.S. Pat. No. 6,103,413 (JP Laid-open Patent Publication No. 2002-516467) mentioned porosity, however did not refer to any means for removing or reducing porosity. KR Patent No. 10-0423181 disclosed fine pores susceptive to gas permeation, wherein the fine pores are made or utilized in the manufacture for the purpose of managing water that is generated by reaction of hydrogen ions and oxygen in the cathode during operating a fuel cell (an electrolyte membrane should be kept moist with water, and thus may serve to deliver the hydrogen ions), and wherein water is absorbed in a porous capillary by addition of a hydrophilic agent such as silica, thereby suppressing gas permeation by capillary action. However, in respect of a material composition, actually there is no disclosed technology for fundamentally suppressing fine pores to reduce gas permeation.

As described above, there have been attempts to reinforce individual characteristics, however, any technique did not meet simultaneously ultimate characteristics required for a separator, i.e. high electrical conductivity, excellent mechanical strength and low gas permeation.

Therefore, studies have been continuously made in the related art to manufacture a separator for a fuel cell having high electrical conductivity and excellent mechanical strength and low gas permeation, and under such a technical environment, the present invention was filed for a patent.

The present invention is designed to solve the above-mentioned problems of the prior arts, and therefore it is an object of the present invention to provide a composition for manufacturing a separator for PEMFC, which improves electrical conductivity, mechanical strength and impermeability to hydrogen or oxygen gas of the separator for PEMFC.

And, it is another object of the present invention to provide a separator for PEMFC manufactured out of the composition for manufacturing a separator for PEMFC.

### SUMMARY OF THE INVENTION

In order to achieve the above-mentioned objects, the present invention provides a composition for manufacturing a separator for PEMFC, including 70 to 80 parts by weight of graphite powder; 3 to 10 parts by weight of carbon fiber; 1 to 5 parts by weight of metal oxide selected from the group consisting of magnesium oxide, aluminum oxide, calcium oxide and their mixtures; and 10 to 30 parts by weight of thermosetting resin selected from the group consisting of vinyl ester resin, phenol resin, epoxy resin and their mixtures.

Preferably, the graphite powder has an average diameter of 140 μm to 160 μm, the carbon fiber has a length of 35 μm to 140 μm, and the metal oxide has a particle size of 50 μm to 150 μm. And, preferably, the composition for manufacturing a separator for PEMFC further includes a curing initiator selected from the group consisting of Dicumyl Peroxide (DCP), Benzoyl Peroxide (BOP), Di-Tert-Butyl Peroxide (DTBP) and their mixtures.

The present invention provides a separator for PEMFC manufactured out of the composition, as well as the above-mentioned composition.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

A composition for manufacturing a separator for PEMFC of the present invention, includes a thermosetting resin selected from the group consisting of vinyl ester resin, phenol resin, epoxy resin and their mixtures, graphite powder as a conductive material, carbon fiber as a reinforcing material for improving a mechanical strength, and metal oxide. Addition of the metal oxide improves a mixed state of the graphite powder and the liquid resin to remove an agglomeration phenomenon of the graphite powder. The agglomeration phenomenon causes larger bubbles than bubbles that may exist in the resin or a mixture of the resin and the graphite, so that the composition may be subject to permeation of gas.

The diameter of the graphite powder is sorted using mesh, and preferably an average diameter of the graphite powder used as a conductive material in the composition of the present invention is 55 μm to 200 μm on the basis that the average diameter is a maximum size of graphite powder measured when a cumulative weight calculated starting from a smaller diameter particle to a larger diameter particle is 50%. In the case that the average diameter of the graphite powder is less than the above-mentioned minimum, it results in poor characteristics including electrical conductivity and flexural strength, and in the case that average diameter of the graphite powder is more than the above-mentioned maximum, it results in disuniform characteristics.

The diameter of the carbon fiber is not limited to a specific value, and the carbon fiber may use all of carbon fibers having a diameter of 5 μm to 8 μm being currently manufactured.

And, in the case that the length of the carbon fiber is less than the above-mentioned minimum, it results in reduction of a mechanical property reinforcing effect, and in the case that the length of the carbon fiber is more than the above-mentioned maximum, it results in insufficient miscibility with the resin.

In the case that the particle size of the metal oxide is less than the above-mentioned minimum, it results in uneasy mixing, and in the case that the particle size of the metal oxide is more than the above-mentioned maximum, it results in disuniform effect.

To reduce the viscosity of the thermosetting resin contained in the composition of the present invention, the thermosetting resin may be used while being dissolved in a styrene monomer or with a curing agent or a curing initiator. The curing initiator may include Dicumyl Peroxide (DCP), Benzoyl Peroxide (BOP) or Di-Tert-Butyl Peroxide (DTBP). Preferably, a usage amount of the curing initiator is 1 weight % to 5 weight % based on the thermosetting resin added to the composition.

The composition of the present invention may be mixed by a mixing device, a ball mill or a kneader. The composition may be all mixed in the mixing device at the same time, however it is preferable to mix a mixture of the graphite powder, the carbon fiber and the metal oxide with a mixture of the resin solution and the curing initiator in the mixing device. Preferably, the mixing temperature is 20° C. to 30° C., and the mixing time is 1 hour or more.

To improve the performance, the composition of the present invention may further include additives, for example a lubricant, a release agent, a stabilizer or a flame retardant, as well as the above-mentioned elements.

Hereinafter, compositions formed as shown in the following Table 1 are classifiably set into examples (1 and 2) and comparative examples (1 to 6), various evaluations are performed on material samples manufactured using the compositions, and technical effects of the present invention are described in detail.

TABLE 1

| Classification | | | Comparative | Comparative | Comparative | Comparative | Comparative | Comparative |
|---|---|---|---|---|---|---|---|---|
| (weight %) | Example 1 | Example 2 | Example 1 | Example 2 | Example 3 | Example 4 | Example 5 | Example 6 |
| Vinyl ester | 13 | 13 | 23 | 18 | 13 | 13 | 13 | 13 |
| Graphite | 76 | 80 | 77 | 69 | 77 | 82 | 84 | 87 |
| Carbon fiber | 8 | 4 | — | 8 | — | — | — | — |
| Magnesium Oxide | 3 | 3 | — | 5 | 10 | 5 | 3 | — |

Evaluation of Characteristics

The following Table 2 shows test results for flexural strength, electrical conductivity and gas permeation of the samples manufactured using the compositions of the above examples 1 and 2 and the comparative examples 1 to 6.

The flexural strength is measured by a test method of ASTM D-790, a value of the electrical conductivity is a reciprocal of a volume resistivity (4-point probe measuring system is used to measure the volume resistivity), and to measure the gas permeation, a pressure container is made such that the manufactured separator is used as a bottom side of the pressure container, and then in the case that a pressure loss is less than 10%, the gas permeation is indicated as good, and in the case that a pressure loss is 10% or more, the gas permeation is indicated as bad. The pressure container has a size of 10 cm wide by 10 cm long by 10 cm high, and only the bottom side is formed of the separator and the five sides is made of stainless steel. The gas permeation is calculated by rendering an initial pressure to 1 atmospheric pressure, after 10 days pass, measuring the pressure, and calculating the pressure loss.

TABLE 2

| | | | Comparative | Comparative | Comparative | Comparative | Comparative | Comparative |
|---|---|---|---|---|---|---|---|---|
| Classification | Example 1 | Example 2 | Example 1 | Example 2 | Example 3 | Example 4 | Example 5 | Example 6 |
| Flexural | 50 | 42 | 29 | 52 | 27 | 27 | 27 | 27 |
| Strength (Mpa) | | | | | | | | |
| Conductivity | 95 | 92 | 50 | 50 | 53 | 74 | 90 | 130 |
| (S/cm) | | | | | | | | |
| Gas permeation | Good | Good | Bad | Good | Good | Good | Good | Bad |
| (cc/sec/cm2) | 1.81 × 10⁻⁷ | 5.16 × 10⁻⁷ | 3.61 × 10⁻⁶ | 7.33 × 10⁻⁸ | 2.24 × 10⁻⁷ | 2.54 × 10⁻⁷ | 2.52 × 10⁻⁷ | 8.15 × 10⁻⁴ |

According to the above Table 2, it is found that the samples manufactured using the compositions for PEMFC for manufacturing a separator for PEMFC (Examples 1 and 2) have better flexural strength, electrical conductivity and impermeability to gas than the samples manufactured using the compositions of the comparative examples.

It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

As such, the separator for PEMFC, manufactured out of the composition for manufacturing a separator for PEMFC according to the present invention has excellent electrical conductivity, mechanical strength and impermeability to hydrogen or oxygen gas, thereby considerably improving the performance of a fuel cell.

What is claimed is:

1. A composition for manufacturing a separator for PEMFC (Proton Exchange Membrane Fuel Cell), comprising:
70 to 80 parts by weight of graphite powder;
3 to 10 parts by weight of carbon fiber;
1 to 5 parts by weight of metal oxide selected from the group consisting of magnesium oxide, aluminum oxide, calcium oxide and their mixtures; and
10 to 30 parts by weight of thermosetting resin selected from the group consisting of vinyl ester resin, phenol resin, epoxy resin and their mixtures.

2. The composition for manufacturing a separator for PEMFC according to claim 1, wherein the graphite powder has an average diameter of 140 μm to 160 μm on the basis that the average diameter is a maximum size of graphite powder measured when a cumulative weight calculated starting from a smaller diameter particle to a larger diameter particle is 50%.

3. The composition for manufacturing a separator for PEMFC according to claim 1,
wherein the carbon fiber has a diameter of 5 μm to 8 μm.

4. The composition for manufacturing a separator for PEMFC according to claim 1,
wherein the carbon fiber has a length of 35 μm to 140 μm.

5. The composition for manufacturing a separator for PEMFC according to claim 1,
wherein the metal oxide has a particle size of 50 μm to 150 μm.

6. The composition for manufacturing a separator for PEMFC according to claim 1, further comprising:
a curing initiator selected from the group consisting of Dicumyl Peroxide (DCP), Benzoyl Peroxide (BOP), Di-Tert-Butyl Peroxide (DTBP) and their mixtures.

7. A separator for PEMFC manufactured out of the composition defined in any one of claims 1 to 6.
